(19) United States
(12) Patent Application Publication
(10) Pub. No.: US 2026/0245592 A1
(43) Pub. Date: Aug. 20, 2026

(54) VIDEO CONTENT POSTING AND CHAPTER RECOGNITION

(71) Applicant: Beijing Zitiao Network Technology Co., Ltd., Beijing (CN)

(72) Inventors: Mei JIANG, Beijing (CN); Mingyu GUO, Beijing (CN); Mufeng LIU, Beijing (CN); Mingfei ZHANG, Beijing (CN); Jinfan XU, Beijing (CN); Xiaojia CHEN, Beijing (CN); Peiping LUO, Beijing (CN); Fanqi MENG, Beijing (CN)

(21) Appl. No.: 19/543,317

(22) Filed: Feb. 18, 2026

(30) Foreign Application Priority Data
Feb. 18, 2025 (CN) 202510180975.5

(51) Int. Cl. G11B 27/34; G06T 7/70; G06V 10/764; G06V 20/40; G06V 20/62; G06V 30/14; G06V 30/148; G06V 30/19; G11B 27/031; H04N 21/845

(52) U.S. Cl. CPC G11B 27/34; G06T 7/70; G06V 10/764; G06V 20/40; G06V 20/635; G06V 30/1448; G06V 30/148; G06V 30/19173; G11B 27/031; H04N 21/8456; G06T 2207/10016; G06T 2207/30241

(57) ABSTRACT

Embodiments of the disclosure relate to a method, an apparatus, a device and a computer-readable storage medium for posting video content and recognizing a chapter. The method proposed herein includes: presenting a posting interface of video content; presenting, in response to obtaining first chapter information recognized based on image content of the video content, guidance information in the posting interface; presenting, in response to triggering of the guidance information, a chapter setting interface of the video content, the chapter setting interface presenting a first group of chapter titles determined based on the first chapter information; and determining, via the chapter setting interface, second chapter information of the video content to post the video content, the second chapter information at least indicating a second group of chapter titles of the video content.

### CROSS-REFERENCE

The present application claims priority to Chinese Patent Application No. 202510180975.5, filed on Feb. 18, 2025, entitled “METHOD, APPARATUS, DEVICE AND STORAGE MEDIUM FOR VIDEO CONTENT POSTING AND CHAPTER RECOGNIZATION”, the entirety of which is incorporated herein by incorporated by reference.

### FIELD

Example embodiments of the present disclosure generally relate to a field of computers, and in particular, to video content posting and chapter recognization.

### BACKGROUND

With rapid development of computer technologies, short video social platforms have gradually become a social medium for people. People may create video content and post it on the short video social platforms to record and share their lives. When creating the video content, people may add a progress bar to the video content, so as to facilitate others to watch the video content.

### SUMMARY

In a first aspect of the present disclosure, a method of posting video content is provided. The method includes: presenting a posting interface of video content; presenting, in response to obtaining first chapter information recognized based on the video content, guidance information in the posting interface; presenting, in response to triggering of the guidance information, a chapter setting interface of the video content, the chapter setting interface presenting a first group of chapter titles determined based on the first chapter information; and determining, via the chapter setting interface, second chapter information of the video content to post the video content, the second chapter information at least indicating a second group of chapter titles of the video content.

In a second aspect of the present disclosure, a method of recognizing a chapter is provided. The method includes: determining text recognition information of an image frame of video content, the text recognition information indicating a first group of text boxes in the image frame; fusing, based on position information of the first group of text boxes, at least one text box in the first group of text boxes to determine a second group of text boxes; determining, based on trajectory information of the second group of text boxes across a plurality of image frames, a chapter text box indicating chapter information from the second group of text boxes; and determining, based on text content in the chapter text box, the chapter information of the video content, the chapter information indicating a plurality of chapter titles of the video content.

In a third aspect of the present disclosure, an apparatus for posting video content is provided. The apparatus includes: a first presentation module configured to present a posting interface of video content; a second presentation module configured to present, in response to obtaining first chapter information recognized based on the video content, guidance information in the posting interface; a third presentation module configured to present, in response to triggering of the guidance information, a chapter setting interface of the video content, the chapter setting interface presenting a first group of chapter titles determined based on the first chapter information; and a first determination module configured to determine, via the chapter setting interface, second chapter information of the video content to post the video content, the second chapter information at least indicating a second group of chapter titles of the video content.

In a fourth aspect of the present disclosure, an apparatus for recognizing a chapter is provided. The apparatus includes: a second determination module configured to determine text recognition information of an image frame of video content, the text recognition information indicating a first group of text boxes in the image frame; a fusion module configured to fuse, in response to the first group of text boxes including a plurality of positionally associated text boxes, the plurality of associated text boxes in the first group of text boxes to determine a second group of text boxes; a selection module configured to determine, based on trajectory information of the second group of text boxes across a plurality of image frames, a chapter text box indicating chapter information from the second group of text boxes; and a third determination module configured to determine, based on text content in the chapter text box, the chapter information of the video content, the chapter information indicating a plurality of chapter titles of the video content.

In a fifth aspect of the present disclosure, a computing device is provided. The device includes at least one processor; and at least one memory, the at least one memory being coupled to the at least one processor and storing instructions for execution by the at least one processor, the instructions, when executed by the at least one processor, causing the device to perform the method of the first aspect or the second aspect.

In a sixth aspect of the present disclosure, a computer-readable storage medium is provided. The computer-readable storage medium has a computer program stored thereon, the computer program being executable by a processor to implement the method of the first aspect or the second aspect.

It would be appreciated that the content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 illustrates a schematic diagram of an example environment capable of implementing embodiments according to the present disclosure;

FIG. 2 illustrates a flowchart of an example process of posting video content according to some embodiments of the present disclosure;

FIGS. 3A to 3C illustrate example interfaces according to some embodiments of the present disclosure;

FIG. 4 illustrates a flowchart of an example process of recognizing a chapter according to some embodiments of the present disclosure;

FIG. 5 illustrates a schematic diagram of an example process of recognizing a chapter according to some embodiments of the present disclosure;

FIG. 6 illustrates an example image frame according to some embodiments of the present disclosure;

FIG. 7 illustrates a schematic structural block diagram of an example apparatus for posting video content according to some embodiments of the present disclosure;

FIG. 8 illustrates a schematic structural block diagram of an example apparatus for recognizing a chapter according to some embodiments of the present disclosure; and

FIG. 9 illustrates a block diagram of a computing device capable of implementing various embodiments of the present disclosure.

### DETAILED DESCRIPTION

The embodiments of the present disclosure will be described in more detail below with reference to the drawings. Although some embodiments of the present disclosure are shown in the drawings, it would be appreciated that the present disclosure may be implemented in various forms and should not be interpreted as limited to the embodiments set forth herein. On the contrary, these embodiments are provided for a more thorough and complete understanding of the present disclosure. It would be appreciated that the drawings and embodiments of the present disclosure are merely for example purposes and are not intended to limit the protection scope of the present disclosure.

It would be noted that titles of any sections/subsections provided herein are not limiting. Various embodiments are described throughout herein, and any type of embodiment may be included under any sections/subsections. Furthermore, the embodiments described in any sections/subsections may be combined with any other embodiments described in the same section/subsection and/or different sections/subsections in any manner.

In the description of the embodiments of the present disclosure, the term “comprising” and its similar terms should be understood as openness, that is, “comprising but not limited to”. The term “based on” should be understood as “based at least in part on”. The term “one embodiment” or “the embodiment” should be understood as “at least one embodiment”. The term “some embodiments” should be understood as “at least some embodiments”. Other definitions, either explicit or implicit, may be included below. The terms “first”, “second” and the like may refer to different or same objects. Other definitions, either explicit or implicit, may be included below.

The embodiments of the present disclosure may involve user data, data obtaining and/or usage, and so on. These aspects follow with corresponding laws, regulations and related provisions. In the embodiments of the present disclosure, all data collection, obtaining, processing, machining, forwarding, usage, etc., are carried out on the premise that the user is aware and confirms. Correspondingly, when implementing the embodiments of the present disclosure, the user should be informed of types, usage scopes, usage scenarios, etc., of possible data or information involved and obtain user authorization through an appropriate manner in accordance with relevant laws and regulations. A specific manner of informing and/or authorizing may vary according to actual situations and application scenarios, and the scope of the present disclosure is not limited in this regard.

If the solutions in this specification and the embodiments involve personal information processing, the processing will be carried out on the premise that there is a legal basis (for example, obtaining the consent of the personal information subject, or being necessary to perform a contract, etc.), and the processing will only be carried out within the scope of the provisions or agreements. If the user refuses to process personal information other than necessary information required for basic functions, it will not affect the user to use the basic functions.

As mentioned above, at present, a progress bar made by a user cannot enable a viewer to accurately jump to a desired chapter, which results in a poor viewing experience for the viewer.

In order to improve the viewing experience of the viewer, a short video social platform needs to recognize video content uploaded by the user, so as to re-make a progress bar based on chapter content in the video content. However, currently used methods of recognizing a chapter cannot achieve accurate recognition.

The embodiments of the present disclosure provide a solution for posting video content. The solution includes: presenting a posting interface of video content; presenting, in response to obtaining first chapter information recognized based on the video content, guidance information in the posting interface; presenting, in response to triggering of the guidance information, a chapter setting interface of the video content, the chapter setting interface presenting a first group of chapter titles determined based on the first chapter information; and determining, via the chapter setting interface, second chapter information of the video content to post the video content, the second chapter information at least indicating a second group of chapter titles of the video content.

In this way, the embodiments of the present disclosure are capable of automatically adding chapter titles by detecting chapter information (e.g., a self-made progress bar) of a video, thereby improving the efficiency of setting chapter titles.

Various example implementations of the solution will be described in detail below in further combination with the drawings.

### Example Environment

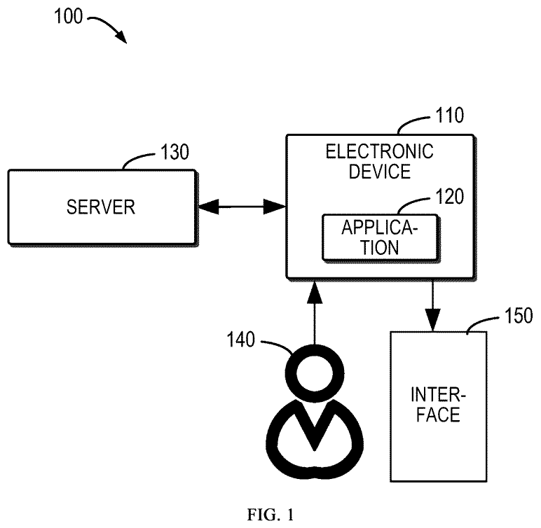

FIG. 1 illustrates a schematic diagram of an example environment 100 capable of implementing embodiments of the present disclosure. As shown in FIG. 1, the example environment 100 may include an electronic device 110.

In the example environment 100, the electronic device 110 may run an application 120 supporting posting video content. The application 120 may be any appropriate type of application for posting video content, examples of which may include but are not limited to a short video social platform or other appropriate applications. A user 140 may interact with the application 120 via the electronic device 110 and/or its attached devices.

In the environment 100 of FIG. 1, if the application 120 is active, the electronic device 110 may present an interface 150 for supporting posting video content through the application 120.

In some embodiments, the electronic device 110 communicates with a server 130 to implement the provision of a service for the application 120. The electronic device 110 may be any type of mobile terminal, fixed terminal or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an e-book device, a game device, or any combination of the foregoing, including accessories and peripherals of these devices or any combination thereof. In some embodiments, the electronic device 110 may also support any type of user-specific interface (such as a “wearable” circuit, etc.).

The server 130 may be an independent physical server, a server cluster or a distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and so on. The server 130 may provide background services for supporting the application 120 for posting video content in the electronic device 110.

A communication connection may be established between the server 130 and the electronic device 110. The communication connection may be established by wired or wireless means. The communication connection may include, but is not limited to, a Bluetooth connection, a mobile network connection, a universal serial bus (USB) connection, a wireless fidelity (WiFi) connection, etc., and the embodiments of the present disclosure are not limited in this regard. In the embodiments of the present disclosure, the server 130 and the electronic device 110 may implement signaling interaction through the communication connection therebetween.

It would be appreciated that the structure and function of each element in the environment 100 are described for illustrative purposes only, without suggesting any limitation to the scope of the present disclosure.

Some example embodiments of the present disclosure will be described below with continued reference to the drawings.

### Posting Video Content

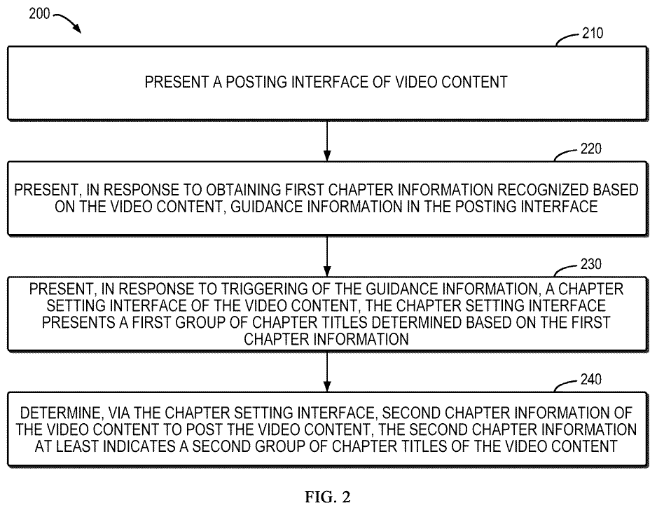

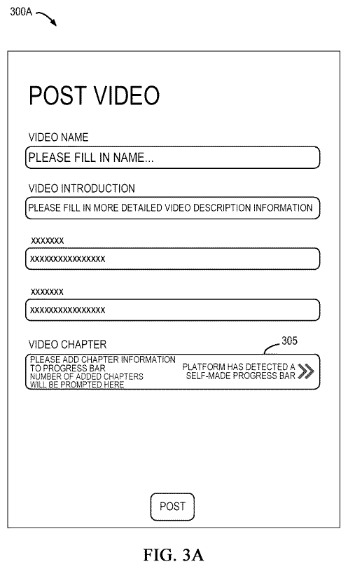

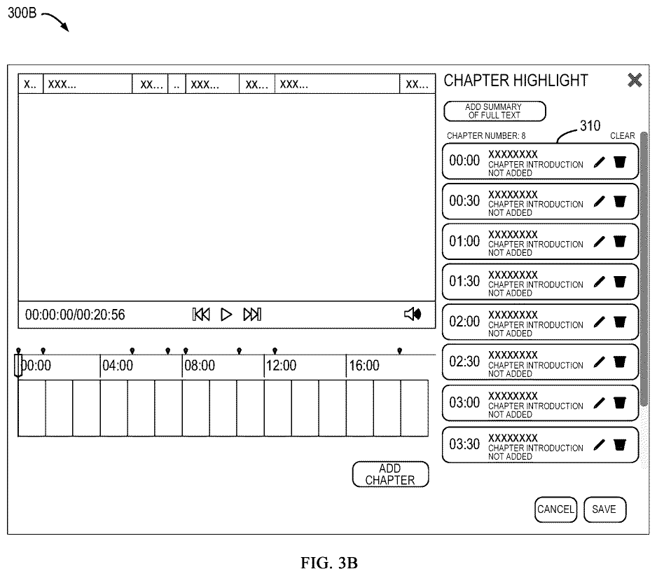

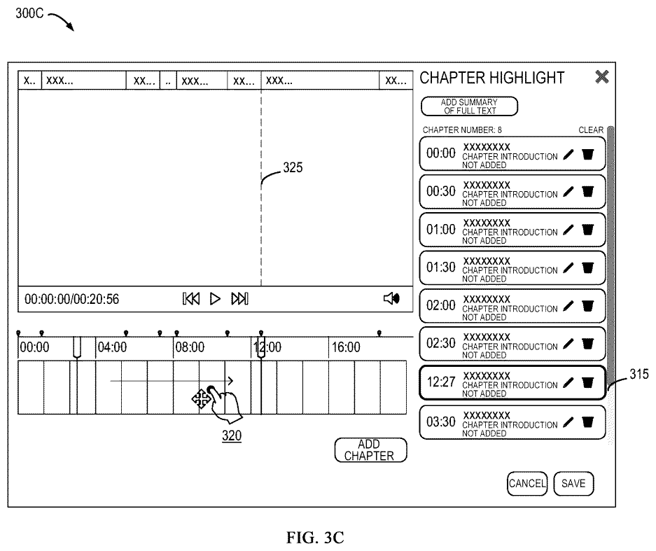

A specific interaction process of posting video content will be described below with reference to FIG. 2 and FIGS. 3A to 3C. FIG. 2 illustrates a flowchart of an example process 200 of posting video content according to some embodiments of the present disclosure. FIGS. 3A to 3C illustrate example interfaces 300A to 300C according to some embodiments of the present disclosure. The process 200 may be implemented by a suitable electronic device, such as the electronic device 110. The interfaces 300A to 300C may be provided, for example, by the electronic device 110 shown in FIG. 1.

As shown in FIG. 2, at block 210, the electronic device 110 presents a posting interface of video content.

In some embodiments, after receiving the video content uploaded by the user 140, the electronic device 110 may present an interface 300A as shown in FIG. 3A, so that the user 140 may edit information related to the video content to complete posting of the video content.

As shown in FIG. 3A, in some embodiments, the interface 300A may include a plurality of editing items and a control for posting the video content. The plurality of editing items are respectively used for editing a plurality of pieces of information related to the video content. The editing item may be, for example, an editing item for editing a name of the video content, an editing item for editing an introduction of the video content, an editing item for editing a type to which the video content belongs, or an editing item for editing chapter information of the video content. After the user 140 completes editing of all editing items, when the electronic device 110 receives a clicking operation of the user 140 on the control, the posted video content may be presented in an interface such as a social platform. Additionally, the interface 200A may further include a preview area for previewing the video content.

At block 220, the electronic device 110 presents, in response to obtaining first chapter information recognized based on the video content, guidance information in the posting interface.

The aforementioned editing item for editing the chapter information may be used by the user 140 to edit the chapter information of the video content. It would be appreciated that the video content uploaded by the user 140 may be video content including chapter information or a progress bar related to the chapter information made by the user 140, or may be video content without the chapter information or the progress bar related to the chapter information made by the user 140. In the former case, the electronic device 110 may recognize the chapter information in the video content. In the latter case, the user 140 may add chapter information to the video content through this editing item.

The case where the video content is video content including chapter information or a progress bar related to the chapter information made by the user 140 will be further described below.

In some embodiments, the electronic device 110 may recognize image content of the video content by invoking a recognition algorithm, to obtain the recognized first chapter information. The image content may indicate, for example, a text element included in at least one image frame of the video content. It would be appreciated that the at least one image frame of the video content may present text elements such as a subtitle, a progress bar related to the chapter information, and text content appearing in a scene corresponding to the image frame. The first chapter information may be determined therefrom by recognizing the image content including these text elements. As an example, the recognition algorithm may be implemented by a suitable device such as the electronic device 110 or the server 130.

In some embodiments, when the electronic device 110 recognizes the first chapter information from the image content of the video content, the electronic device 110 may present the guidance information 305 in the posting interface. As shown in FIG. 3A, the guidance information 305 may include “Platform has detected a self-made progress bar”.

The first chapter information may indicate a plurality of chapter titles determined based on the chapter content or the progress bar related to the chapter content made by the user 140 in the video content. Additionally, the first chapter information may further indicate, for example, a start time point or an end time point of the plurality of chapters.

At block 230, the electronic device 110 presents, in response to triggering of the guidance information, a chapter setting interface of the video content. The chapter setting interface presents a first group of chapter titles determined based on the first chapter information.

As shown in FIG. 3B, in some embodiments, when the electronic device 110 receives the triggering of the guidance information from the user 140, the electronic device 110 may present the chapter setting interface such as an interface 300B. The chapter setting interface may include at least an editing panel and an auxiliary panel for editing the chapter information. The user 140 may edit the chapter information by operating the editing panel and the auxiliary panel.

In some embodiments, the editing panel may include a plurality of unit panels corresponding to the first group of chapter titles. Each unit panel is used for editing chapter information of one chapter title in the first group of chapter titles. The first group of chapter titles may be determined, for example, based on the first chapter information. For example, the interface 300B may display a plurality of chapter titles extracted from the progress bar made by the user, such as a chapter title 310.

In some embodiments, the unit panel may include, for example, a first area for editing title names of the first group of chapter titles, a second area for editing introductions of the first group of chapter titles, and a third area for editing time points related to the first group of chapter titles. The first area may present the title names of the first group of chapter titles, for example. The second area may present the introductions of the first group of chapter titles, for example. The third area may present the time points related to the first group of chapter titles, such as start time points or end time points of the chapter titles. As an example, when the electronic device 110 receives a clicking operation from the user 140 on any editing area of the unit panel, the electronic device 110 may cause the corresponding editing area on the chapter setting interface to present an editing mode, so that the user 140 may edit corresponding information. In another example, the unit panel may further include an editing control. When the electronic device 110 receives a clicking operation from the user 140 on the editing control, the electronic device 110 may cause the corresponding unit panel on the chapter setting interface to present an editing mode.

In some embodiments, the electronic device 110 may obtain time points presented in the third area by associating the first group of chapter titles with a first group of time points of the video content. The first group of time points may be, for example, predetermined time points. As an example, the first group of time points may be determined based on a number of the first group of chapter titles. For example, the electronic device 110 may predetermine the first group of time points based on a ratio of duration of the video content to the number of the first group of chapter titles. Alternatively, the electronic device 110 may predetermine the first group of time points as time points separated by a fixed duration.

In some embodiments, the auxiliary panel may include at least a video preview area and a time axis. The video preview area may be used for previewing the video content. Since the video content includes a progress bar, and the progress bar may indicate start time points or end time points of the plurality of chapter titles, as well as video playback progress, the user 140 may adjust the time point in the third area by referring to the video content in the video preview area. The time axis may be used for obtaining a time point. When the electronic device 110 receives a choosing operation from the user 140 on any time point on the time axis, the electronic device 110 may obtain the specific time of the time point chosen by the user 140 through the time axis. Furthermore, the electronic device 110 may synchronize the time point chosen by the user 140 from the time axis to the third area by associating the time axis with the time points in the third area, thereby realizing an adjustment of the time points in the third area.

Additionally, the chapter setting interface may further include a control for adding and deleting a chapter.

It would be appreciated that a scenario of presenting the chapter setting interface through the triggering of the guidance information may be, for example, that the user 140 uploads the video content including the first chapter information for the first time. The user 140 may cause the electronic device 110 to present the setting interface based on operating on the guidance information, so as to edit the chapter information of the video content. For another scenario, that is, a scenario where the user 140 is not editing the chapter information of the video content for the first time, the user 140 may click on the editing item for editing the chapter information or a corresponding control, so that the electronic device 110 presents the chapter setting interface. Specifically, when the electronic device 110 receives a clicking operation from the user 140 on the editing item or the corresponding control, the electronic device 110 may present the chapter setting interface.

At block 240, the electronic device 110 determines, via the chapter setting interface, second chapter information of the video content to post the video content.

In some embodiments, the second chapter information at least indicates a second group of chapter titles of the video content. As an example, the user may confirm the plurality of chapter titles indicated by the first chapter information, and may post the video to associate the video with a plurality of automatically recognized chapter titles.

In some other embodiments, the electronic device 110 may further receive an editing operation on the first group of chapter titles to add a new chapter title or modify an existing chapter title. Accordingly, the electronic device 110 may determine the second group of chapter titles.

Additionally, the second chapter information may indicate, for example, chapter introductions corresponding to the second group of chapter titles and start time points or end time points of the second group of chapter titles in the video content.

It would be appreciated that since the second chapter information may be at least divided into three parts, i.e., the second group of chapter titles, the chapter introductions, and the corresponding start time points or end time points, the implementation of the aforementioned step of “determining the second chapter information of the video content” may also be divided into implementations of three parts.

For determining the second group of chapter titles, in some embodiments, the second group of chapter titles may be determined based on the first group of chapter titles. As an example, when the electronic device 110 receives an operation of adding, deleting or modifying the first group of chapter titles from the user 140, the electronic device 110 may adjust the first group of chapter titles to the second group of chapter titles and present them in the editing panel.

In a specific example, when the electronic device 110 receives a clicking operation from the user 140 on the first area or the editing control of a unit panel, the electronic device 110 causes the first area to enter the editing mode. Then, when the electronic device 110 receives an input operation from the user in the first area, the electronic device 110 causes the first area to present a chapter title input by the user 140. Through the above process, the electronic device 110 may adjust the first group of chapter titles to the second group of chapter titles via the chapter setting interface. The process of adjusting the first group of chapter titles to the second group of chapter titles based on an operation of adding a chapter or an operation of deleting a chapter is similar to the above process, and thus is not described in detail here.

For determining the chapter introductions corresponding to the second group of chapter titles, the implementation process may refer to the implementation process of determining the second group of chapter titles, and thus is not described in detail here.

For determining the start time points or end time points corresponding to the second group of chapter titles, in some embodiments, the electronic device 110 may implement it based on the following process: associating, via the chapter setting interface, the second group of chapter titles with a second group of time points of the video content. Specifically, the second group of time points may be determined based on the editing operation of the user 140.

As shown in FIG. 3C, the electronic device 110 presents, in response to a selection of a chapter title 315 in the second group of chapter titles, an indicator element in a video area of the chapter setting interface. In some embodiments, after the electronic device 110 receives the selection operation from the user on the chapter title in the second group of chapter titles, the electronic device 110 may cause the unit panel corresponding to the chapter title in the chapter setting interface to present a selected state. As an example, the selected state may be represented by marking color on the unit panel or bolding the outline of the unit panel.

In some embodiments, the indicator element 325 may represent a start time point or an end time point corresponding to the chapter title. When the time point in the third area is expressed as the start time point of the chapter title, the indicator element may represent the start time point corresponding to the chapter title. On the contrary, when the time point in the third area is expressed as the end time point of the chapter title, the indicator element may represent the end time point corresponding to the chapter title. As an example, the indicator element 325 may be an auxiliary line.

Then, the electronic device 110 updates, in response to receiving an adjustment operation 320 on the start time point or the end time point, a position of the indicator element in the video preview area. When receiving a drag-and-drop operation 320 from the user, the indicator element 325 may move accordingly to indicate the adjusted start time point or the adjusted end time point.

In this way, the embodiments of the present disclosure may help the user to more accurately locate boundary positions between different chapters by displaying the indicator element, thereby improving efficiency of setting chapter information.

### Recognizing Video Chapters

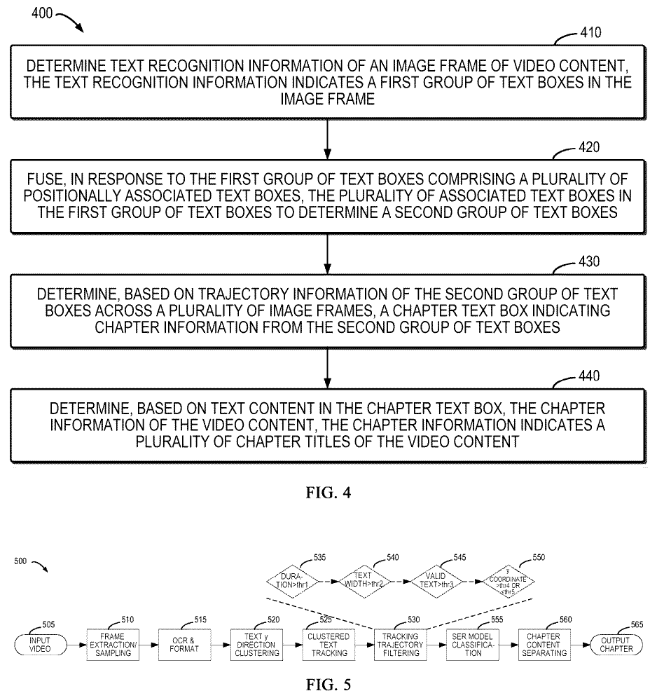

FIG. 4 illustrates a flowchart of an example process 400 of recognizing a chapter according to some embodiments of the present disclosure. The process 400 may be implemented at the server 130. The process 400 will be described below with reference to FIG. 1.

As shown in FIG. 4, at block 410, the server 130 determines text recognition information of an image frame of video content, the text recognition information indicating a first group of text boxes in the image frame.

The process 400 will be described below with reference to FIG. 5. As shown in FIG. 5, the server 130 may obtain an input video 505, and may perform frame extraction or sampling on the input video 505 at block 510. For example, the server 130 may extract image frames from the input video 505 at a fixed interval (for example, every N seconds).

Furthermore, at block 515, the server 130 may perform text recognition on the sampled image frame. For example, the server 130 may use OCR (Optical Character Recognition) to recognize text content in the image frame, so as to determine a first group of text boxes in the image frame.

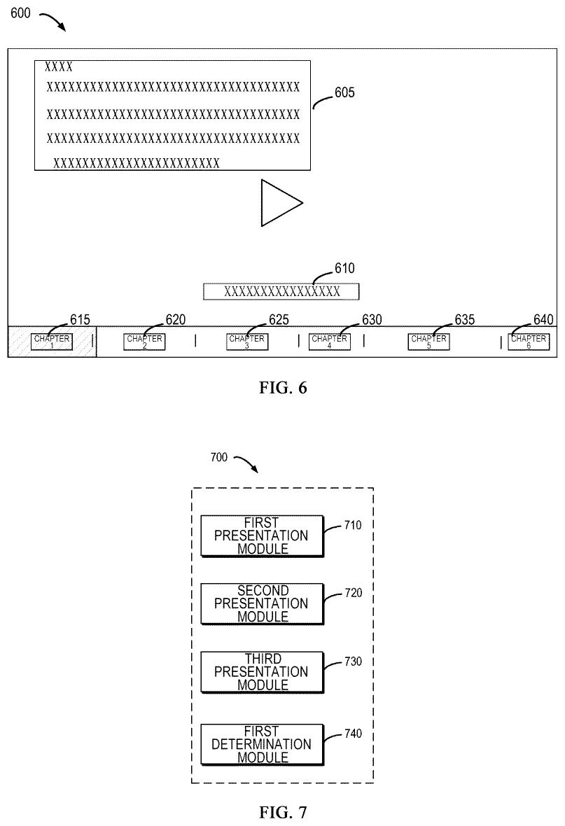

FIG. 6 illustrates an example image frame 600 according to some embodiments of the present disclosure. As shown in FIG. 6, the server 130 may use a text recognition module to determine a first group of text boxes from the image frame 600, for example, a text box 605, a text box 610, a text box 615, a text box 620, a text box 625, a text box 630, a text box 635 and a text box 640.

At block 420, the server 130 fuses, in response to the first group of text boxes including a plurality of positionally associated text boxes, the plurality of associated text boxes in the first group of text boxes to determine a second group of text boxes.

Specifically, the server 130 may determine position information of the first group of text boxes. Furthermore, the server 130 may determine the plurality of positionally associated text boxes from the group of text boxes based on the position information of the first group of text boxes.

At block 520, the server 130 may perform clustering on the text boxes in a predetermined direction (for example, Y-axis direction). Taking FIG. 6 as an example, the server 130 may determine position information of the text box 605 to the text box 640 in the image frame 600 to perform aggregation on the text boxes in the Y direction.

As an example, differences between coordinate values of the text box 615 to the text box 640 in the predetermined direction are less than a threshold, and may be determined as positionally associated. Furthermore, the server 130 may aggregate the text box 615 to the text box 640 into one text box, so that the first group of text boxes may be updated to the second group of text boxes.

At block 430, the server 130 determines, based on trajectory information of the second group of text boxes across a plurality of image frames, a chapter text box indicating chapter information from the second group of text boxes.

Specifically, at block 525, the server 130 may determine the trajectory information of the second group of text boxes across the plurality of sampled image frames. As an example, the server 130 may match text boxes in different image frames to determine the trajectory information of the text boxes.

Specifically, the server 130 may determine that two text boxes in different image frames match based on indicators such as similarity of the text content in the text boxes, positional relationship between the text boxes, similarity of the text box sizes, and continuity of frames in which the text boxes appear.

Furthermore, at block 530, the server 130 determines, based on a comparison between the trajectory information and the at least one filtering condition, the chapter text box satisfying at least one filtering condition from the second group of text boxes.

Specifically, the filtering condition may include detecting at block 535 whether a duration of a text box is greater than a predetermined duration. For example, if the duration of the text box is less than or equal to the predetermined duration, it may be determined as text content that does not appear for a long time in the video content, and therefore is not a chapter text made by the user.

Additionally or alternatively, the filtering condition may include detecting at block 535 whether the size of the text box is greater than a predetermined size. For example, if the size (for example, width) of the text box is less than or equal to a predetermined width, the text box may be determined as a chapter text not made by the user.

Additionally or alternatively, the filtering condition may include detecting at block 540 whether a number of valid characters in the text box is greater than a predetermined number, where the valid characters are determined based on the types of characters in the text box. As an example, the valid characters may represent non-symbol type characters in the text box. Furthermore, if the number of valid characters in the text box is less than or equal to the predetermined number, the text box may be determined as a chapter text not made by the user.

Additionally or alternatively, the filtering condition may include detecting at block 540 that a distance from a text box to an upper boundary or to a lower boundary is less than a predetermined distance. For example, since the chapter text made by the user is usually at the top or bottom position of the video content, if the distances from the text box to the upper boundary and to the lower boundary are greater than or equal to the threshold, it may be determined as a chapter text not made by the user.

Furthermore, at block 555, in response to the second group of text boxes including a plurality of candidate text boxes satisfying the at least one filtering condition, the server 130 may determine the chapter text box from the plurality of candidate text boxes using a classification model.

As an example, the classification model may include a SER (Semantic Entity Recognition) model. In some embodiments, the SER model may be implemented using a multimodal transformer. Specifically, the server 130 may construct a text feature based on the text content and position information corresponding to the plurality of candidate text boxes. For example, the server 130 may use a text encoder to encode the text content and coordinate information of each text box, thereby determining the text feature corresponding to each text box.

In addition, the server 130 may construct a visual feature based on image frames corresponding to the plurality of candidate text boxes. Specifically, a plurality of sub-images of the image frames are encoded using an image encoder to construct the visual feature, where the image encoder is trained using contrastive learning of sample images and sample texts. As an example, the image encoder may include an encoding unit in a CLIP (Contrastive Language-Image Pretraining) model.

Furthermore, the server 130 may provide the text feature and the visual feature to the classification model to determine a classification result indicating whether the plurality of candidate text boxes are chapter text boxes. For example, the classification model may output a classification result of whether each candidate text box is a chapter text box.

In this way, the embodiments of the present disclosure may be used to filter non-chapter text areas that are incorrectly recalled.

Continuing to refer to FIG. 4, at block 440, the server 130 determines, based on the text content in the chapter text box, the chapter information of the video content, the chapter information indicating a plurality of chapter titles of the video content.

As shown in FIG. 5, at block 560, the server 130 may separate the text content in the chapter text box. Specifically, the server 130 may detect a group of predetermined separators in the text content. As an example, such predetermined separators may include predetermined separators such as “|”, “-”, and so on.

Furthermore, the server 130 may separate, based at least on the group of predetermined separators, the text content into a plurality of chapter titles corresponding to a plurality of chapters, as the chapter information of the video content. Taking FIG. 6 as an example, the server 130 may separate the content of an aggregated text box corresponding to the text box 615 to the text box 640 to determine a plurality of chapter titles, namely, “Chapter 1”, “Chapter 2”, “Chapter 3”, “Chapter 4”, “Chapter 5” and “Chapter 6”.

In some embodiments, in order to improve recognition accuracy of the chapter text, the server 130 may further obtain a sub-image corresponding to the chapter text box, and may provide the sub-image to a text recognition model to recognize the text content in the chapter text box. The text recognition model may be, for example, a CTC (Connectionist Temporal Classification)-based prediction.

In the CTC-based prediction process, the text recognition model may insert a blank character at each output moment to align an input sequence, and may use the blank character to perform separation of the chapter text content, thereby avoiding the problem of text sticking.

In this way, the embodiments of the present disclosure are capable of recognizing chapter text (e.g., self-made progress bar) in the video content by tracking of the text box, thereby improving accuracy of chapter recognition.

### Example Apparatus and Device

The embodiments of the present disclosure further provide corresponding apparatuses for implementing the above methods or processes. FIG. 7 illustrates a schematic structural block diagram of an example apparatus 700 for posting video content according to some embodiments of the present disclosure. The apparatus 700 may be implemented as the electronic device 110 or included in the electronic device 110. Each module/component in the apparatus 700 may be implemented by hardware, software, firmware, or any combination thereof.

As shown in FIG. 7, the apparatus 700 includes: a first presentation module 710 configured to present a posting interface of video content; a second presentation module 720 configured to present, in response to obtaining first chapter information recognized based on the video content, guidance information in the posting interface; a third presentation module 730 configured to present, in response to triggering of the guidance information, a chapter setting interface of the video content, the chapter setting interface presenting a first group of chapter titles determined based on the first chapter information; and a first determination module 740 configured to determine, via the chapter setting interface, second chapter information of the video content to post the video content, the second chapter information at least indicating a second group of chapter titles of the video content.

In some embodiments, the second group of chapter titles is determined based on the first group of chapter titles.

In some embodiments, the first chapter information is determined based on a text element included in at least one image frame of the video content.

In some embodiments, the apparatus 700 further includes an association module configured to: associate the first group of chapter titles with a first group of time points of the video content, the first group of time points being determined based on a number of the first group of chapter titles; and associate, via the chapter setting interface, the second group of chapter titles with a second group of time points of the video content.

In some embodiments, the association module is further configured to: present, in response to a selection of a chapter title in the second group of chapter titles, an indicator element in a video preview area of the chapter setting interface, the indicator element representing a start time point or an end time point corresponding to the chapter title; update, in response to receiving an adjustment operation on the start time point or the end time point, a position of the indicator element in the video preview area; and associate the chapter title with the adjusted start time point or the adjusted end time point.

In some embodiments, the chapter setting interface further includes a time axis corresponding to the video content, and the position of the indicator element is determined based on a position of the start time point or the end time point on the time axis.

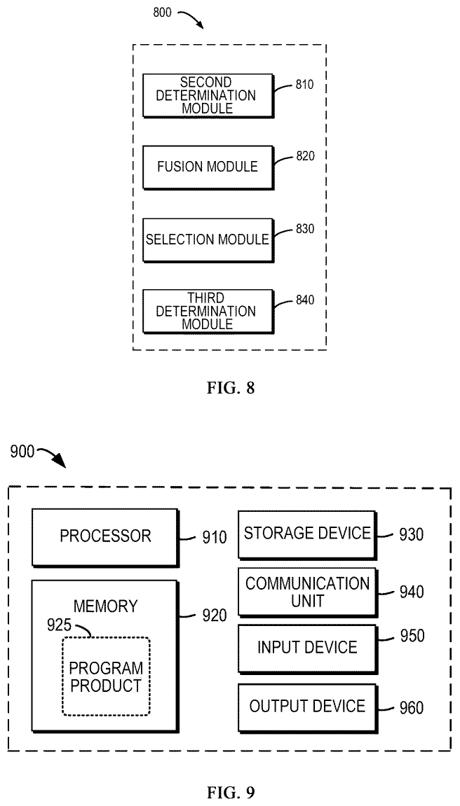

FIG. 8 illustrates a schematic structural block diagram of an example apparatus 800 for posting video content according to some embodiments of the present disclosure. The apparatus 800 may be implemented as the electronic device 110 or included in the electronic device 110. Each module/component in the apparatus 800 may be implemented by hardware, software, firmware, or any combination thereof.

As shown in FIG. 8, the apparatus 800 includes: a second presentation module 810 configured to determine text recognition information of an image frame of video content, the text recognition information indicating a first group of text boxes in the image frame; a fusion module 820 configured to fuse, in response to the first group of text boxes including a plurality of positionally associated text boxes, the plurality of associated text boxes in the first group of text boxes to determine a second group of text boxes; a selection module 830 configured to determine, based on trajectory information of the second group of text boxes across a plurality of image frames, a chapter text box indicating chapter information from the second group of text boxes; and a third determination module 840 configured to determine, based on text content in the chapter text box, the chapter information of the video content, the chapter information indicating a plurality of chapter titles of the video content.

In some embodiments, the apparatus 800 further includes a fourth determination module configured to: determine position information of the first group of text boxes; and determine, based on the position information of the first group of text boxes, the plurality of positionally associated text boxes from the group of text boxes.

In some embodiments, differences between coordinate values of the plurality of text boxes in a predetermined direction are less than a threshold.

In some embodiments, the selection module 830 is further configured to determine, based on a comparison between the trajectory information and at least one filtering condition, the chapter text box satisfying at least one filtering condition from the second group of text boxes.

In some embodiments, the at least one filtering condition includes at least one of the following: a duration of a text box being greater than a predetermined duration; a size of a text box being greater than a predetermined size; a number of valid characters in a text box being greater than a predetermined number, the valid characters being determined based on types of characters in the text box; and a distance from a text box to an upper boundary or to a lower boundary being less than a predetermined distance.

In some embodiments, the selection module 830 is further configured to determine, in response to the second group of text boxes including a plurality of candidate text boxes satisfying the at least one filtering condition, the chapter text box from the plurality of candidate text boxes using a classification model.

In some embodiments, the selection module 830 is further configured to: construct a text feature based on text content and position information corresponding to the plurality of candidate text boxes; construct a visual feature based on image frames corresponding to the plurality of candidate text boxes; and provide the text feature and the visual feature to the classification model to determine a classification result, the classification result indicating whether the plurality of candidate text boxes are chapter text boxes.

In some embodiments, the selection module 830 is further configured to encode a plurality of sub-images of the image frames using an image encoder to construct the visual feature, where the image encoder is trained using contrastive learning of sample images and sample texts.

In some embodiments, the third determination module 840 is further configured to detect a group of predetermined separators in the text content; and separate, based at least on the group of predetermined separators, the text content into a plurality of chapter titles corresponding to a plurality of chapters, as the chapter information of the video content.

In some embodiments, the apparatus 800 further includes an obtaining module configured to: obtain a sub-image corresponding to the chapter text box; and provide the sub-image to a text recognition model to recognize the text content in the chapter text box.

Units included in the apparatus 700 or the apparatus 800 may be implemented in various manners, including software, hardware, firmware, or any combination thereof. In some embodiments, one or more units may be implemented using software and/or firmware, such as machine-executable instructions stored on a storage medium. In addition to machine-executable instructions or as an alternative, some or all units in the apparatus 700 or the apparatus 800 may be implemented at least partially by one or more hardware logic components. As an example, rather than a limitation, example types of hardware logic components that may be used include field programmable gate arrays (FPGAs), application specific integrated circuits (ASICs), application specific standard parts (ASSPs), system on chips (SOCs), complex programmable logic devices (CPLDs), and so on.

As shown in FIG. 9, the electronic device 900 is in a form of a general-purpose electronic device. Components of the electronic device 900 may include, but are not limited to, one or more processors or processing units 910, a memory 920, a storage device 930, one or more communication units 940, one or more input devices 950, and one or more output devices 960. The processing unit 910 may be a physical or virtual processor and may execute various processes based on the programs stored in the memory 920. In a multi-processor system, a plurality of processing units executes computer executable instructions in parallel to improve the parallel processing capability of the electronic device 900.

The electronic device 900 typically includes a plurality of computer storage media. Such medium may be any available medium accessible to the electronic device 900, including, but not limited to, volatile and non-volatile medium, removable and non-removable medium. The memory 920 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 930 may be removable or non-removable medium, and may include a machine-readable medium such as a flash drive, a magnetic disk, or any other medium, which may be used to store information and/or data and may be accessed in the electronic device 900.

The electronic device 900 may further include additional removable/non-removable, volatile/non-volatile memory medium. Although not shown in FIG. 9, it is possible to provide a disk driver for reading from a removable, non-volatile magnetic disk or writing to a removable, non-volatile magnetic disk (such as a “floppy disk”), and an optical disk driver for reading from a removable, non-volatile optical disk or writing to a removable, non-volatile optical disk. In these cases, each driver may be connected to a bus (not shown) by one or more data medium interfaces. The memory 920 may include a computer program product 925 having one or more program modules configured to perform various methods or acts of the various embodiments of the present disclosure.

The communication unit 940 enables communication with other electronic devices through the communication medium. Additionally, the functions of the components of the electronic device 900 may be implemented by a single computing cluster or a plurality of computing machines, which may communicate through communication connections. Therefore, the electronic device 900 may use a logical connection with one or more other servers, network personal computers (PCs) or another network node to operate in a networked environment.

The input device 950 may be one or more input devices, such as a mouse, a keyboard, a tracking ball, etc. The output device 960 may be one or more output devices, such as a display, a speaker, a printer, etc. The electronic device 900 may also communicate with one or more external devices (not shown) through the communication unit 940 as needed, the external devices such as a storage device, a display device, etc., communicate with one or more devices that enable a user to interact with the electronic device 900, or communicate with any device (e.g., a network card, a modem, etc.) that enables the electronic device 900 to communicate with one or more other electronic devices. Such communication may be performed via input/output (I/O) interfaces (not shown).

According to an example implementation of the present disclosure, a computer-readable storage medium is provided, the computer-readable storage medium has computer executable instructions stored thereon, where the computer executable instructions are executed by a processor to implement the method described above. According to an example implementation of the present disclosure, a computer program product is further provided, the computer program product is tangibly stored on a non-transitory computer-readable medium and includes computer executable instructions, the computer executable instructions being executed by a processor to implement the method described above.

Various aspects of the present disclosure are described herein with reference to flowcharts and/or block diagrams of methods, apparatuses, devices and computer program products implemented according to the present disclosure. It would be appreciated that each block of the flowcharts and/or block diagrams, and each combination of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that when these instructions are executed by the processing unit of the computer or other programmable data processing apparatus, an apparatus for implementing the functions/actions specified in one or more blocks of the flowcharts and/or block diagrams is produced. These computer-readable program instructions may also be stored in a computer-readable storage medium, these instructions cause a computer, a programmable data processing apparatus, and/or other devices to work in a specific manner, so that the computer-readable medium storing the instructions includes an article of manufacture, which includes instructions for implementing various aspects of the functions/actions specified in one or more blocks of the flowcharts and/or block diagrams.

The computer-readable program instructions may be loaded onto a computer, other programmable data processing apparatuses, or other devices, such that a series of operating steps are performed on the computer, other programmable data processing apparatuses, or other devices to produce a computer-implemented process, such that the instructions executed on the computer, other programmable data processing apparatus, or other devices implement the functions/actions specified in one or more blocks of the flowcharts and/or block diagrams.

The flowcharts and block diagrams in the drawings illustrate the possibly implemented architectures, functions and operations of the systems, methods and computer program products according to a plurality of implementations of the present disclosure. In this regard, each block in the flowcharts or block diagrams may represent a module, program segment or part of an instruction, and the module, program segment or part of an instruction includes one or more executable instructions for implementing the specified logical functions. In some alternative implementations, the functions marked in the blocks may also occur in an order different from that is marked in the drawings. For example, two consecutive blocks may actually be executed substantially in parallel, or they may sometimes be executed in a reverse order, depending on the functions involved. It would also be noted that each block in the block diagrams and/or the flowcharts, and each combination of blocks in the block diagrams and/or the flowcharts may be implemented by a special-purpose hardware-based system that executes specified functions or actions, or may be implemented by a combination of special-purpose hardware and computer instructions.

The implementations of the present disclosure have been described above, and the above description is for example, non-exhaustive, and not limited to the disclosed implementations. Without departing from the scope of the illustrated implementations, many modifications and variations will be apparent to those of ordinary skill in the art. The terms used herein are chosen to best explain the principles of the implementations, practical applications or improvements to the technologies in the market, or to enable other ordinary skilled persons in the art to understand the implementations disclosed herein.

I/We claim:

1. A method for posting video content, comprising:
presenting a posting interface of video content;
presenting, in response to obtaining first chapter information recognized based on the video content, guidance information in the posting interface;
presenting, in response to triggering of the guidance information, a chapter setting interface of the video content, the chapter setting interface presenting a first group of chapter titles determined based on the first chapter information; and
determining, via the chapter setting interface, second chapter information of the video content to post the video content, the second chapter information at least indicating a second group of chapter titles of the video content.

2. The method of claim 1, wherein the second group of chapter titles is determined based on the first group of chapter titles.

3. The method of claim 1, wherein the first chapter information is determined based on a text element comprised in at least one image frame of the video content.

4. The method of claim 1, further comprising:
associating the first group of chapter titles with a first group of time points of the video content, the first group of time points being determined based on a number of the first group of chapter titles; and
associating, via the chapter setting interface, the second group of chapter titles with a second group of time points of the video content.

5. The method of claim 4, wherein associating, via the chapter setting interface, the second group of chapter titles with the second group of time points of the video content comprises:
presenting, in response to a selection of a chapter title in the second group of chapter titles, an indicator element in a video preview area of the chapter setting interface, the indicator element representing a start time point or an end time point corresponding to the chapter title;
updating, in response to receiving an adjustment operation on the start time point or the end time point, a position of the indicator element in the video preview area; and
associating the chapter title with the adjusted start time point or the adjusted end time point.

6. The method of claim 5, wherein the chapter setting interface further comprises a time axis corresponding to the video content, and the position of the indicator element is determined based on a position of the start time point or the end time point on the time axis.

7. A method of recognizing a chapter, comprising:
determining text recognition information of an image frame of video content, the text recognition information indicating a first group of text boxes in the image frame;
fusing, in response to the first group of text boxes comprising a plurality of positionally associated text boxes, the plurality of associated text boxes in the first group of text boxes to determine a second group of text boxes;
determining, based on trajectory information of the second group of text boxes across a plurality of image frames, a chapter text box indicating chapter information from the second group of text boxes; and
determining, based on text content in the chapter text box, the chapter information of the video content, the chapter information indicating a plurality of chapter titles of the video content.

8. The method of claim 7, further comprising:
determining position information of the first group of text boxes; and
determining, based on the position information of the first group of text boxes, the plurality of positionally associated text boxes from the group of text boxes.

9. The method of claim 7, wherein differences between coordinate values of the plurality of text boxes in a predetermined direction are less than a threshold.

10. The method of claim 7, wherein determining, based on the trajectory information of the second group of text boxes across the plurality of image frames, the chapter text box indicating the chapter information from the second group of text boxes comprises:
determining, based on a comparison between the trajectory information and at least one filtering condition, the chapter text box satisfying at least one filtering condition from the second group of text boxes.

11. The method of claim 10, wherein the at least one filtering condition comprises at least one of the following:
a duration of a text box being greater than a predetermined duration;
a size of a text box being greater than a predetermined size;
a number of valid characters in a text box being greater than a predetermined number, the valid characters being determined based on types of characters in the text box; and
a distance from a text box to an upper boundary or to a lower boundary being less than a predetermined distance.

12. The method of claim 10, wherein determining the chapter text box satisfying the at least one filtering condition from the second group of text boxes comprises:
determining, in response to the second group of text boxes comprising a plurality of candidate text boxes satisfying the at least one filtering condition, the chapter text box from the plurality of candidate text boxes using a classification model.

13. The method of claim 12, wherein determining the chapter text box from the plurality of candidate text boxes using the classification model comprises:
constructing a text feature based on text content and position information corresponding to the plurality of candidate text boxes;
constructing a visual feature based on image frames corresponding to the plurality of candidate text boxes; and
providing the text feature and the visual feature to the classification model to determine a classification result, the classification result indicating whether the plurality of candidate text boxes are chapter text boxes.

14. The method of claim 13, wherein constructing the visual feature based on the image frames corresponding to the plurality of candidate text boxes comprises:
encoding a plurality of sub-images of the image frames using an image encoder to construct the visual feature, wherein the image encoder is trained using contrastive learning of sample images and sample texts.

15. The method of claim 7, wherein determining, based on the text content in the chapter text box, the chapter information of the video content comprises:
detecting a group of predetermined separators in the text content; and
separating, based at least on the group of predetermined separators, the text content into a plurality of chapter titles corresponding to a plurality of chapters, as the chapter information of the video content.

16. The method of claim 7, further comprising:
obtaining a sub-image corresponding to the chapter text box; and
providing the sub-image to a text recognition model to recognize the text content in the chapter text box.

17. A computing device, comprising:
at least one processor; and
at least one memory, the at least one memory being coupled to the at least one processor and storing instructions for execution by the at least one processor, the instructions, when executed by the at least one processor, causing the computing device to perform acts comprising:
presenting a posting interface of video content;
presenting, in response to obtaining first chapter information recognized based on the video content, guidance information in the posting interface;
presenting, in response to triggering of the guidance information, a chapter setting interface of the video content, the chapter setting interface presenting a first group of chapter titles determined based on the first chapter information; and
determining, via the chapter setting interface, second chapter information of the video content to post the video content, the second chapter information at least indicating a second group of chapter titles of the video content.

18. The computing device of claim 17, wherein the second group of chapter titles is determined based on the first group of chapter titles.

19. The computing device of claim 17, wherein the first chapter information is determined based on a text element comprised in at least one image frame of the video content.

20. The computing device of claim 17, wherein the acts further comprise:
associating the first group of chapter titles with a first group of time points of the video content, the first group of time points being determined based on a number of the first group of chapter titles; and
associating, via the chapter setting interface, the second group of chapter titles with a second group of time points of the video content.
